(19) United States
(12) Patent Application Publication
(10) Pub. No.: US 2015/0145670 A1
(43) Pub. Date: May 28, 2015

(54) ELECTRONIC DEVICE AND CONTROL METHOD THEREOF

(71) Applicant: Kabushiki Kaisha Toshiba, Tokyo (JP)

(72) Inventor: Junya TSURUOKA, Tokyo (JP)

(21) Appl. No.: 14/484,168

(22) Filed: Sep. 11, 2014

Related U.S. Application Data
(60) Provisional application No. 61/908,987, filed on Nov. 26, 2013.

(51) Int. Cl. G08B 25/10

(52) U.S. Cl. CPC G08B 25/10
USPC 340/539.11

(57) ABSTRACT

There is provided an electronic device a user wears, the device including: a controller configured to determine whether the user is wearing the electronic device based on an input from a sensor; and configured to notify the user of an event in a first mode when the determination is made that the user is wearing the electronic device, and in a second mode when the determination is made that the user is not wearing the electronic device.

### CROSS-REFERENCE TO RELATED APPLICATION(S)

This application claims priority from U.S. Provisional Patent Application No. 61/908,987 filed on Nov. 26, 2013, the entire contents of which are incorporated herein by reference.

### TECHNICAL FIELD

The present invention relates to an electronic device and a control method thereof.

### BACKGROUND ART

There are techniques that notify users of the arrival of incoming mails and the like with the use of wearable devices; however, when the users are not wearing the wearable devices, the techniques sometimes cannot notify the users of the arrival. In the conventional arts, it is difficult for the users to notice events such as urgent mails, incoming calls to be immediately answered, and the like at the timing immediately after the events occur when the users are not wearing the wearable devices that define electronic devices.

### BRIEF DESCRIPTION OF THE DRAWINGS

FIG. 1 is an external perspective view of a line of sight detection system according to a first embodiment;

FIG. 2 is a block diagram of functional components of the line of sight tracking system;

FIG. 3 is a flow chart that shows to explain the operation of the embodiment;

FIG. 4 is a functional block diagram to explain the internal constitution of a second embodiment; and

FIG. 5 is a flow chart that shows to explain the operation of the embodiment.

### MODE FOR CARRYING OUT THE INVENTION

Hereinafter, descriptions of the embodiments will be provided.

### First Embodiment

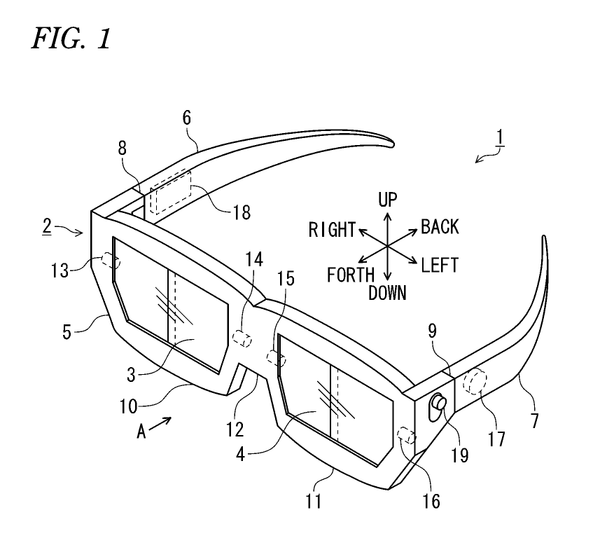

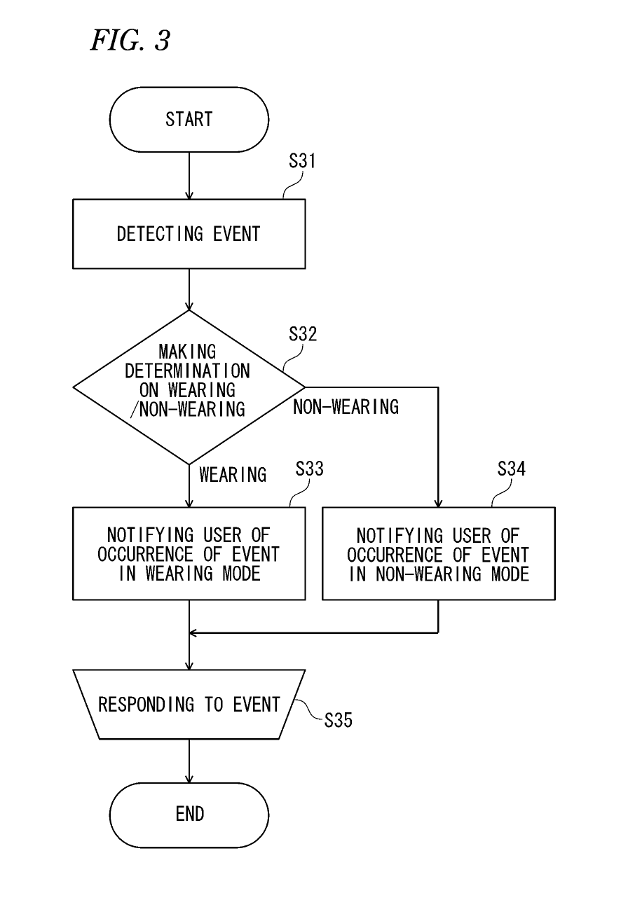

A description of an example of an eye glass type device that is a first embodiment will be provided referring to FIG. 1. to FIG. 3. In the example of the eye glass type device, three effects of a vibration effect, a sound effect, and a visual effect are assumed as notification means with which a user is notified. The present embodiment is not limited to a case where all of these three effects are always used in combination. The present embodiment includes also a case where these three effects are used, and a case where any two or one effect is used. In addition, also in terms of points where vibration and sound are generated, and intensity of the vibration and sound, the present embodiment is not limited to a case where the effects are always used in combination. Changing of the three vibration, sound, and visual effects depending on device-wearing time and device-non-wearing time includes patterns of changing the means itself such as a pattern of using vibration during the device-wearing time, and a pattern of using sound during the device-non-wearing time. The notifications described in the embodiments include both of conveying some sort of information (an alarm indicating a newly arriving e-mail, the time to perform a scheduled task, and the like, receipt of a phone call, and the like) to the user, and prompting the user to check details by conveying some sort of information to be checked while the information is not meant to convey specific information. In the first embodiment, “points” to make notifications are divided into the following points depending on the device-wearing time and the device-non-wearing time.

First, in the notification by vibration, there are an element of a point that vibrates, and an element of large intensity and small intensity of vibration. The point that vibrates is set to be only an ear section of the eye glass type device during the device-wearing time, and set to be an ear section and a nose section of the eye glass type device during the device-non-wearing time. The reasons thereof are as follows.

The reason why only the ear section is set during the device-wearing time is because if vibrate, the eye glasses have an annoying feel. On top of this, it turns out vibrating the display of the eye glass type device, which is found inconvenient. Rather, only slight vibration of the ear section is enough to give a notification to the user during the device-wearing time.

On the other hand, if the vibration is too small during the device-non-wearing time, the user is unlikely to notice the vibration. In this regard, the vibration should be large enough to the extend that the user can readily notice by vibrating the ear and nose sections simultaneously.

Further, especially in the case of the eye glass type device, a shape of the eye glass allows the user to place the device in a variety of ways. The vibration of the ear section could be sometimes not enough depending on the ways of placing the eye glass type device during the device-non-wearing time (for instance, placing the eye glass type device with the ear section being floated). Consequently, the eye glass type device needs to be provided with a plurality of vibration points, and the vibration points need to be selectively activated depending on the situations of the device-wearing and the device-non-wearing.

In addition, the intensity of the vibration is set small during the device-wearing time, and set large during the device-non-wearing time. During the device-wearing time, the eye glass type device makes intimate contact with the user, even weak vibration may be sufficient for the user, while the user may have incomfortable feeling to the device when the vibration is set strong, moreover, the vibration of the entire eye glass type device causes the display and the like to vibrate, which turns out being operationally inconvenient. Hence, the vibration shall be set small during the device-wearing time.

As for the eye glass type device, there is also a situation of non-contact with the user during the device-non-wearing time, which results in concern of the eye glass type device being not functioning as notification means when the vibration is weak. Hence, the vibration during the device-non-wearing time shall be set larger than the vibration during the device-wearing time when a notification by vibration is made.

In the notification by sound, there are an element of a point where a sound is generated, and an element of a sound volume. The point where a sound is generated is set to be only the vicinity of an ear during the device-wearing time, and set to be the vicinity of an ear and “a point other than the vicinity of an ear”, or only “a point other than the vicinity of an ear” during the device-non-wearing time.

In the case of the wearable eye glass type device, a sound output in the vicinity of an ear sometimes has the shape of an inner ear canal type earphone. The output of this shape is not suitable for emitting to the outside a sound of volume enough to notify the user who is not wearing the device while being suitable for providing high-quality sound to the user.

If it is assumed that a notification sound is emitted to the outside, a separate speaker is required. However, such a speaker has a disadvantage against a canal type earphone and the like in terms of providing high-quality sound to the user.

In other words, it is preferable that the eye glass type device should be provided with a plurality of sound output devices, and the sound output devices should be selectively activated depending on the device-wearing and the device-non-wearing. That is, a device in the vicinity of an ear is selectively activated during the device-wearing time, and a device in the vicinity of an ear and a device other than the vicinity of an ear, or only a device other than the vicinity of an ear is selectively activated during the device-non-wearing time.

In addition, the intensity of the vibration is set small during the device-wearing time, and set large during the device-non-wearing time. During the device-wearing time, even a small notification sound can be heard as if whispering. Meanwhile, a large notification sound could annoy the user. Hence, the sound volume during the device-wearing time is suppressed.

The user is generally apart from the device during the device-non-wearing time, so that it is difficult for the user to notice the sound of volume of a whispering level. Hence, the device notifies the users with a large sound volume in comparison with the device-wearing time.

In the visual notification, there is an element of a display portion. This display portion is set to be a point having a visual effect that is inward during the device-wearing time (a section that is seen during the device-wearing time: a display and the like), and set to be a point having a visual effect that is inward and a visual effect that is outward (a section that is not seen during the device-wearing time) during the device-non-wearing time.

In the wearable eye glass type device, visual portions by the user aor noticeable portions for the user are different between the device-wearing time and the device-non-wearing time. Thus, when a notification to the user is made by blinking light, icon display, or the like, points to display the notification (devices: a display, an LED, and the like) shall be selectively activated depending on the device-wearing time and the device-non-wearing time. During the device-wearing time, a visual notification shall be made on a display located in the vicinity of the eye, or an LED that can be identified by the user during the device-wearing time, or the like. During the device-non-wearing time, a visual notification shall be made at a portion that is noticeable when seen from the outside of the device by blinking light, icon display, or the like

Hereinafter, a description of the first embodiment will be provided with reference to the drawings. A line of sight detection system 1 according to the first embodiment defines a line of sight detection system of the head-mounted type, and examples of the type include a cap type, a helmet type, a goggle type, and an eye glass type. Line of sight detection systems of the cap type and the helmet type have a configuration of being mounted on a head with a line of sight detection device portion hanging down from a flange portion. Line of sight detection systems of the goggle type and the eye glass type have a shape similar to work goggles and so-called eye glasses, and are small and light.

In the present embodiment, the line of sight detection system of the eye glass type is mainly described. FIG. 1 is an external perspective view of the line of sight detection system 1 according to the present embodiment. The line of sight detection system 1 includes a frame 2, a right lens 3, and a left lens 4. The frame 2 includes a front 5, a right temple 6, a left temple 7, a right hinge section 8, and a left hinge section 9. The front 5 includes a right rim section 10 and a left rim section 11 that respectively surround the right and left lenses 3 and 4, and a bridge section 12 that connects the right rim section 10 and a left rim section 11. The right and left lenses 3 and 4 are fitted fixedly into grooves (not illustrated) provided on the inward sides of the right and left rim sections 10 and 11. It is to be noted that the arrows indicating the up, down, back, forth, right and left directions of the line of sight detection system 1 are shown in FIG. 1.

A camera 13 for detecting line of sight, vibrating means 14, 15, a camera 16 for photographing a field of view, a speaker 17 including a power-supply module, and a main circuit board 18 including a control module, an image processing module and the like are disposed inside of the frame 2. For example, the camera 13 for detecting line of sight, the vibrating means 14, 15, and the camera 16 for photographing a field of view are disposed inside of the front 5, the speaker 17 is disposed inside of the left temple 7, and the main circuit board 18 is disposed inside of the right temple 6. These electrical circuit parts are connected by, for example, lead wires or flexible printed wiring boards (not illustrated).

The main circuit board 18 includes an electrostatic sensor, an acceleration sensor, and a pressure sensor that are not illustrated.

A switch 19 arranged to turn on and off the power of the line of sight detection system 1 is provided on a part of the outer surface of the frame 2. For example, the switch 19 is disposed closer to the front on the left temple 7.

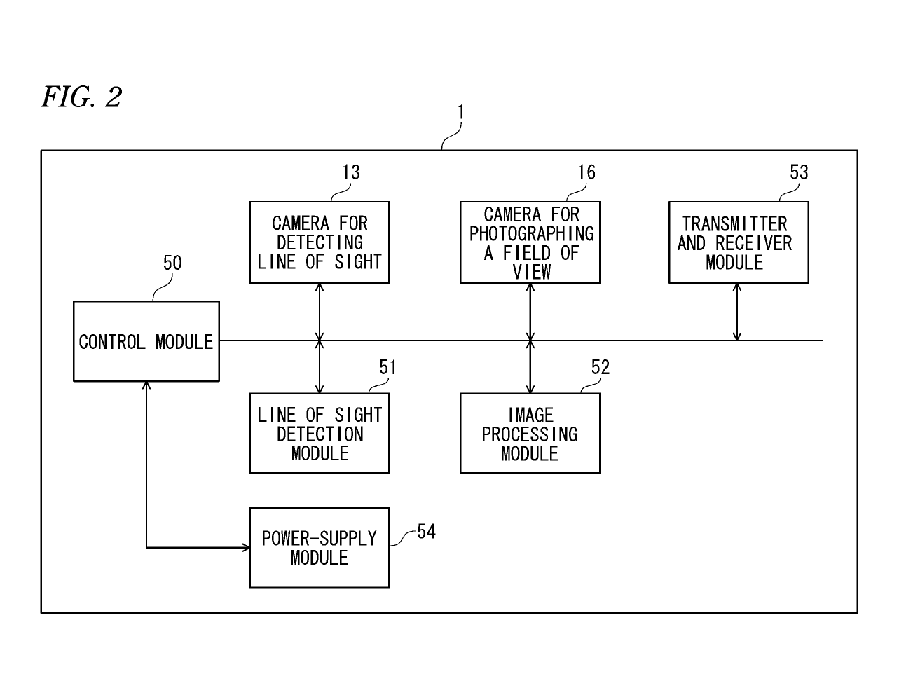

FIG. 2 is a block diagram of functional components of the line of sight tracking system 1. A control module 50 includes an MCU (Micro Controller Unit) that is a built-in microprocessor incorporating a computer system on a single integrated circuit, is provided with peripheral functions such as ROM, RAM, and I/O relations, and is arranged to control the operation of the entire line of sight detection system 1.

The control module 50 has the functions of controlling the camera 13 for detecting line of sight, the camera 16 for photographing a field of view, a line of sight detection module 51, an image processing module 52, and a transmitter and receiver module 53 that are connected. These functions define applications carried out by the MCU inside of the control module 50, are usually stored in the ROM inside of the control module 50, and are retrieved and carried out by the MCU when used.

The line of sight detection module 51 receives output signals of the camera 13 for detecting line of sight, converts the signals to signals appropriate for communication, and transmits the signals to the transmitter and receiver module 53. For example, the line of sight detection module 51 makes the position of a pupil of a user into a pattern and data based on the output signals of the camera 13 for detecting line of sight, and calculates the position of the line of sight based on the data. In addition, the direction of the line of sight and the distance to an object may be converted into data based on a right and left parallax. It is to be noted that the calculation of the position of the line of sight and the conversion into data may be carried out by the line of sight detection system 1, or may be carried out by a host device by receiving video data of the line of sight detection camera from the line of sight detection system 1.

The image processing module 52 receives output signals of the camera 16 for photographing a field of view, converts the signals to signals appropriate for communication, and transmits the signals to the transmitter and receiver module 53. The transmitter and receiver module 53 has the function of transmitting the line of sight detection data, field of view image data, and the like to an external host device via an antenna and the like. A power-supply module 54 has charge of control of a mounted battery, control over power-saving, and the like.

Main portions of the control module 50, the line of sight detection module 51, the image processing module 52, and the transmitter and receiver module 53 are mounted on the main circuit board 18. In addition, a portion of the power-supply module 54 is disposed on a power-supply unit (not illustrated) and another portion is mounted on the main circuit board 18.

FIG. 3 is a flow chart that shows to explain the operation of the present embodiment.

Step S31: The control module 50 detects, for example, an event such as receipt of a phone call and occurrence of an alarm via the transmitter and receiver module 53, and goes to the following step S32.

Step S32: The control module 50 makes a determination on whether the user is wearing a wristwatch-type mobile terminal 1a or not based on the output of the line of sight detection module 51, or the outputs of the electrostatic sensor, the acceleration sensor, and the pressure sensor.

Step S33: When the determination that the user is wearing the wristwatch-type mobile terminal 1a is made in the step S32, the control module 50 notifies the user of the occurrence of the event in a wearing mode (first mode), and goes to the following step S35.

Step S34: When the determination that the user is not wearing the wristwatch-type mobile terminal 1a is made in the step S32, the control module 50 notifies the user of the occurrence of the event in a non-wearing mode (second mode), and goes to the following step S35.

Step S35: The user takes necessary steps in response to the event, and the steps are terminated. The necessary steps include, for example, in the case of an incoming call, a flow such that the user checks a caller, and makes a call if necessary, or puts an answering machine on to this incoming call to send a reply to that effect when busy.

It is to be noted that shown in FIG. 3 is an example where the determination on whether the user is not wear the wristwatch-type mobile terminal 1a or not is made after the notification of the event; however, it is also possible to make the determination on whether the user is not wear the wristwatch-type mobile terminal 1a or not before the notification of the event. For example, the device may have a configuration such that the device controls (makes a determination on) device-wearing and device-non-wearing states before the occurrence of the event (that is, always), and responses differently to the occurrence of the event depending on the states.

In the wearable eye glass type device described above (having the function of superimposing a computer image on a field of view), when a notification by vibration at the time of arrival of an incoming mail is made, the sections that vibrate, the number of the sections that vibrate, and the intensity of the vibration are changed depending on the device-wearing and the device-non-wearing.

### Second Embodiment

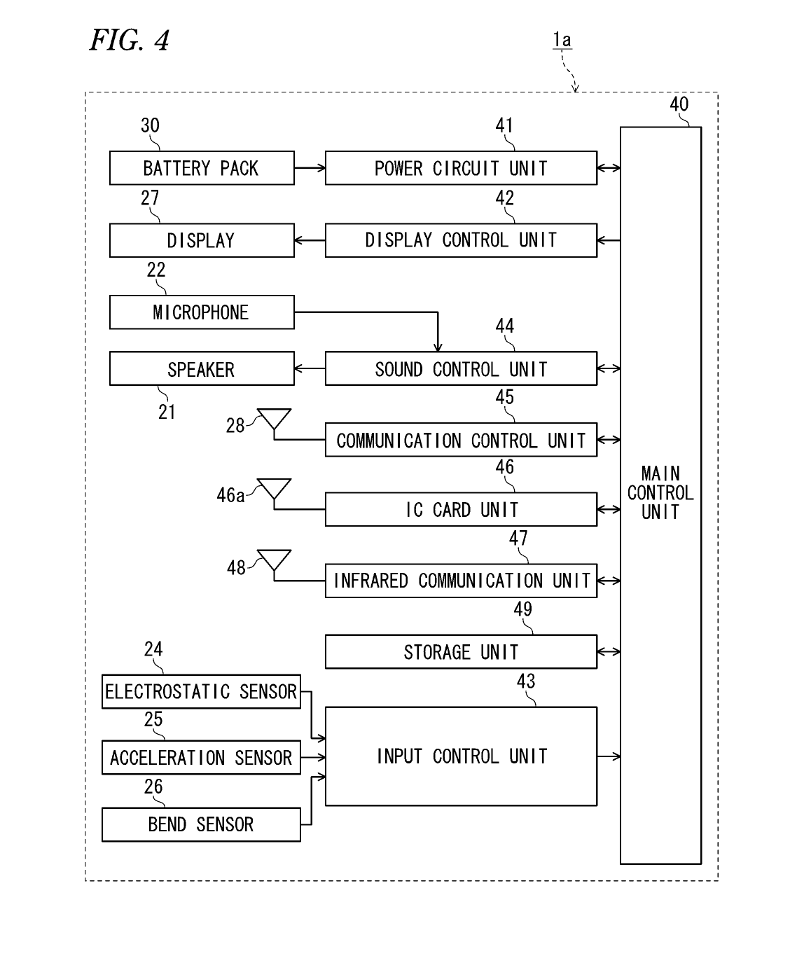

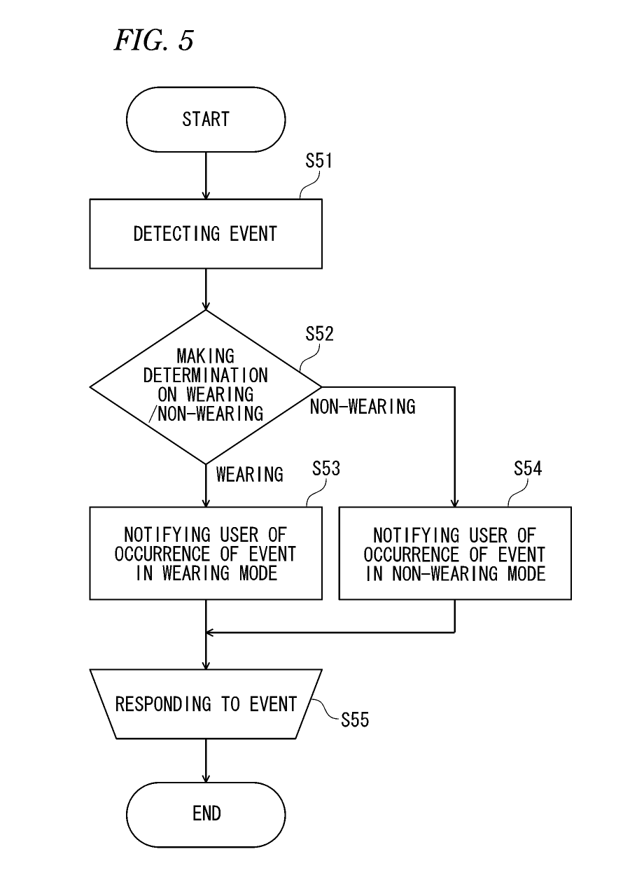

A description of an example of a wristwatch-type device that is a second embodiment will be provided referring to FIG. 4. to FIG. 5. Explanations of the components common with the embodiment 1 are omitted. In the second embodiment, “points” to make notifications are arbitrary both during the device-wearing time and during the device-non-wearing time.

In the notification by vibration, there are an element of a point that vibrates, and an element of the large intensity and small intensity of vibration.

The wristwatch-type device is in intimate contact with a user during the device-wearing time while being apart form a user during the device-non-wearing time, too. In addition, it is assumed that the wristwatch-type device is placed, for example, on a desk in a variety of ways during the device-non-wearing time due to its shape. For example, there are a way of placing the wristwatch-type device with its dial face down, a way of placing the wristwatch-type device with its belt section down, and a way of placing the wristwatch-type device as if erecting a ring that would become a circle as viewed from above.

It is also preferable to set a plurality of vibration points during the device-non-wearing time in order to set up vibration at the level of notifying the user even if the wristwatch-type device is placed in any of the ways. Since the user is in contact with the device during the device-wearing time, even weak vibration is enough to give a notification to the user. The user is sometimes in non-contact with the device during the device-non-wearing time, so that there is an apprehension that the device does not function as notification means when the vibration is weak. Hence, the vibration during the device-non-wearing time is set larger than the vibration during the device-wearing time when a notification by vibration is made.

In the notification by sound, there are an element of a point where a sound is generated, and an element of a sound volume.

In the case of the wristwatch-type device, the sound of volume is enough if it reaches the ear of the user from the wrist during the device-wearing time. During the device-non-wearing time, there is a case where the distance is larger than the above case, or there is a case where the sound is cut when the device is in a bag, a pocket, or the like. Hence, in order to vary the sound of volume depending on the device-wearing and the device-non-wearing, the wristwatch-type device has a configuration of changing a plurality of sound outputs.

In the notification by visual, there is an element of a display portion.

In the case of the wristwatch-type device, a notification is usually made sufficiently by a portion corresponding to a dial face of a wristwatch during the device-wearing time. However, during the device-non-wearing time, the dial face is not always noticeable (e.g., when placed with turning the dial face down, the device can detect the direction of gravity using an acceleration sensor 25 to be described later). Thus, it is also preferable that the device has a configuration of making a visual notification by another section such as a belt section. Alternatively, the device changes the sections to make notifications depending on the device-wearing and the device-non-wearing.

FIG. 4 is a functional block diagram to explain the internal constitution of the wristwatch-type mobile terminal 1a.

The wristwatch-type mobile terminal 1a includes a main control unit 40, a power circuit unit 41, a display control unit 42, an input control unit 43, a sound control unit 44, a communication control unit 45, an IC card unit 46, an infrared communication unit 47, a storage unit 49, an electrostatic sensor 24, the acceleration sensor 25, and a bend sensor 26 that are connected communicably to one another by buses. It is to be noted that the bend sensor 26 may be replaced with a pressure sensor or the like.

The main control unit 40 includes a CPU (Central Processing Unit) (not illustrated) and comprehensively controls the wristwatch-type mobile terminal 1a while performing a variety of arithmetic processing, control processing, and the like. In addition, the main control unit 40 functions as processing control means in the present embodiment.

The power circuit unit 41 includes a power supply source (a battery pack 30 shown in FIG. 4, and the like) and supplies electric power to each unit from the power supply source when the power is ON to make the wristwatch-type mobile terminal 1a operable.

The display control unit 42 includes a display interface for a display 27. The display control unit 42 displays document data, image data, and the like on the display 27 based on the control of the main control unit 40. In addition, the display control unit 42 disables or enables displaying on the display 27 based on the control of the main control unit 40.

The input control unit 43 includes a display interface for the electrostatic sensor 24, the acceleration sensor 25, and the bend sensor 26. Detecting detection signals from the electrostatic sensor 24, the acceleration sensor 25, and the bend sensor 26, the input control unit 43 generates signals appropriate for the detection signals to transfer the signals to the main control unit 40. The input control unit 43 functions as input accepting means.

The sound control unit 44 generates analog sound signals from a sound collected by a microphone 22 to convert the analog sound signals into digital sound signals based on the control of the main control unit 40. In addition, obtaining the digital sound signals, the sound control unit 44 converts the digital sound signals into analog sound signals based on the control of the main control unit 40 to output the analog sound signals as a sound from a speaker 21.

Incidentally, a long-distance wireless antenna 28 defines an antenna used in order that the communication control unit (communication control unit 45 shown in FIG. 4) transmits and receives a radio wave to and from a base station (not illustrated) to perform long-distance wireless communication. If having a configuration of being disposed at a position other than the position of the belt section with which a hand is in contact, the long-distance wireless antenna 28 has a beneficial effect since antenna characteristics thereof are not affected even the user is wearing a glove-type mobile terminal 1, and excellent radiation characteristics are obtained.

The communication control unit 45 performs data restore by performing, for example, inverse spread spectrum processing on the received signals that are received from the base station via the long-distance wireless antenna 28 based on the control of the main control unit 40. This data is transmitted to the sound control unit 44 to be outputted from a speaker 11, transmitted to the display control unit 42 to be displayed on the display 27, or stored in the storage unit 49 according to instructions of the main control unit 40. In addition, when obtaining the sound data collected by the microphone 22 or the data stored in the storage unit 49, the communication control unit 45 performs, for example, spread spectrum processing on the data to transmit the data to the base station via the long-distance wireless antenna 28 based on the control of the main control unit 40.

A short-distance wireless antenna 46a defines an antenna with which an IC card unit (IC card unit 46 shown in FIG. 4) such as Felica (registered trademark) provided to the wristwatch-type mobile terminal 1a performs short-distance wireless communication with an external reader/writer device. The short-distance wireless antenna 46a is disposed, for example, at approximately center position of the wristwatch-type mobile terminal 1a. In addition, the IC card unit 46 is disposed at a predetermined position of the wristwatch-type mobile terminal 1a.

The IC card unit 46 includes, for example, a billing data control unit, and performs short-distance wireless communication at a very close distance of about several centimeters with a reader/writer device (not illustrated) via the short-distance wireless antenna 46a. In the short-distance wireless communication, the billing data control unit (not illustrated) can be operated using electric power obtained by receiving a radio wave from the reader/writer device. In addition, not limited to this manner, the billing data control unit may be operated with power supplied from the power circuit unit 41 inside the wristwatch-type mobile terminal 1a.

The infrared communication unit 47 is provided in order to transmit and receive data from and to another device including an infrared communication function via infrared rays. The wristwatch-type mobile terminal 1a is used by directing an infrared communication antenna 48 of the infrared communication unit 47 disposed at a predetermined position toward an infrared communication unit of an opposed device during the time of data transmission and reception.

The storage unit 49 includes a ROM (Read Only Memory) and a hard disk arranged to store a processing program used by the main control unit 40 and data necessary for the processing, a non-volatile memory, a RAM (Random Access Memory) arranged to temporarily store data used when the main control unit 40 performs processing, and the like.

FIG. 5 is a flow chart that shows to explain the operation of the present embodiment.

Step S51: The main control unit 40 detects an event such as receipt of a message via the communication control unit 45, and goes to the following step S52.

Step S52: The main control unit 40 makes a determination on whether the user is wearing the wristwatch-type mobile terminal 1a or not based on the outputs of the electrostatic sensor 24, the bend sensor 26, and the like.

Step S53: When the determination that the user is wearing the wristwatch-type mobile terminal 1a is made in the step S52, the main control unit 40 notifies the user of the occurrence of the event in a wearing mode (first mode), and goes to the following step S55.

Step S54: When the determination that the user is not wearing the wristwatch-type mobile terminal 1a is made in the step S52, the main control unit 40 notifies the user of the occurrence of the event in a non-wearing mode (second mode), and goes to the following step S55.

Step S55: The user takes necessary steps in response to the event, and the steps are terminated. The necessary steps include, for example, in the case of arrival of a mail, a flow such that the user checks a sender and a title, and reads the mail if necessary, and further send a reply to the mail if necessary.

It is to be noted that shown in FIG. 5 is an example where the determination on whether the user is wearing the wristwatch-type mobile terminal 1a or not is made after the notification of the event; however, it is also possible to make the determination on whether the user is wearing the wristwatch-type mobile terminal 1a or not before the notification of the event. For example, the device may have a configuration such that the device controls (makes a determination on) device-wearing and device-non-wearing states before the occurrence of the event (that is, always), and responses differently to the occurrence of the event depending on the states.

Described above is the function of changing the operation of the wearable device depending on whether or not the user is wearing the wearable device. In general, the user is close to or in intimate contact with the wearable device when the user is wearing the wearable device while the distance between the user and the wearable device is larger when the user is not wearing the wearable device than the distance when the user is wearing the wearable device. It is required that the operation of the wearable device should be changed depending on the distance. For example, in the case of the eye glass type device, the device is close to the eye or the ear when the user is wearing the device. If generated at these positions, strong light, large sound, and strong vibration have an annoying feel to the user. Meanwhile, when not wearing the eye glass type device, the user could not notice unless large sound is generated. The present embodiment is directed to changing the method for notifying the user of information (arrival of an incoming mail and receipt of a phone call, alarms, and the like) depending on wearable device-wearing and wearable device-non-wearing states.

That is, when the vibration is too strong during the device-wearing time, the entire eye glass vibrates to have an annoying feel to the user. In addition, when the vibration is strong, the screen of the wearable device vibrates, too, which is found operationally inconvenient. Meanwhile, when not wearing the eye glass type device, the user cannot notice a notification by vibration if the notification is weak.

First, the device includes means for recognizing the device-wearing time and the device-non-wearing time. In addition, the device includes means for recognizing the change in wearing state. Next, the device and the application on the device are capable of changing the operation depending on the device-wearing time and the device-non-wearing time, or the change in wearing state.

The present invention relating to function control of the wearable device allows the way for making a notification by vibration or the like to be automatically changed depending on the device-wearing time and the device-non-wearing time, which can achieve a notification by vibration or the like that is free from inconvenience in both the use cases of the device-wearing time and the device-non-wearing.

It is to be noted that the present invention is not limited to the above-described embodiments, and various changes may be made without departing from the scope of the invention.

In addition, appropriate combinations of a plurality of constituent elements disclosed in the above embodiments can form a variety of inventions. For example, some constituent elements may be excluded from all the constituent elements shown in the embodiments. Further, constituent elements according to different embodiments may be appropriately combined.

1. An electronic device a user wears, the device comprising:
a controller configured to determine whether the user is wearing the electronic device based on an input from a sensor; and
configured to notify the user of an event in a first mode when the determination is made that the user is wearing the electronic device, and in a second mode when the determination is made that the user is not wearing the electronic device.

2. The electronic device according to claim 1, wherein
the event is corresponding to information received by the electronic device.

3. The electronic device according to claim 1, wherein
the event is corresponding to function of the electronic device.

4. The electronic device according to claim 1, wherein
the controller is configured to notify by at least any one of sound, display, and vibration.

5. The electronic device according to claim 4, wherein
the controller is configured to make at least any one of sound and vibration stronger in the second mode than in the first mode.

6. The electronic device according to claim 4, wherein
the controller is configured to increase the number of points where the vibration is generated more in the second mode than in the first mode.

7. A control method in an electronic device a user wears, the method comprising:
determining whether the user is wearing the electronic device based on an input from a sensor; and
notifying the user of an event in a first mode when the determination is made that the user is wearing the electronic device, and in a second mode when the determination is made that the user is not wearing the electronic device.
